(19) United States
(12) Patent Application Publication
(10) Pub. No.: US 2012/0019067 A1
(43) Pub. Date: Jan. 26, 2012

(54) Power Converter with Communication Capability

(76) Inventor: Kung-Neng Lee, Taoyuan (TW)

(21) Appl. No.: 13/188,011

(22) Filed: Jul. 21, 2011

Related U.S. Application Data
(63) Continuation of application No. 12/365,591, filed on Feb. 4, 2009.

(51) Int. Cl. H02J 1/00

(52) U.S. Cl. 307/31

(57) ABSTRACT

Systems for providing a wireless capable power converter are provided. The power converter can include a power converter module operatively connected to a detachable I/O module. A voltage input, a first voltage output, and second voltage output can be disposed in, on, or about the power converter module. Power, at a first voltage, can be distributed via a first connection device. Power, at a second voltage, can be distributed via a first Universal Serial Bus connection device. One or more I/O devices, a wireless transceiver, and a second Universal Serial Bus connection device can be disposed in, on, or about the I/O module. The first and second Universal Serial Bus connection devices can be complimentary, permitting the operative connection of the I/O and power converter modules. The second voltage output can provide all or a portion of the power consumed by the wireless transceiver and I/O devices.

### CROSS REFERENCE TO RELATED APPLICATIONS

This application is a continuation of and claims priority to U.S. patent application Ser. No. 12/365,591, filed on Feb. 4, 2009, which is incorporated by reference as if fully set forth herein.

### BACKGROUND OF THE INVENTION

1. Field of the Invention

Embodiments of the present invention generally relate to power converters for electrical devices. More particularly, embodiments of the present invention relate to power converters having built-in wireless communication capability.

2. Description of the Related Art

Power is supplied to many portable electrical devices using a power converter suitable for converting alternating current (“A.C.”) at a first voltage (usually in the range of 110VAC to 240VAC) to a direct current (“D.C.”) supplied at a second, reduced, voltage (usually in the range of 5VDC to 50VDC). A typical power converter will contain a step-down transformer to reduce the AC line voltage, a rectifier bridge to alter the A.C. voltage waveform to approximate a D.C. voltage waveform, and one or more voltage regulator circuits to further refine the D.C. voltage waveform and to supply D.C. voltage within the allowable input power parameters of the electric device.

The transformer, rectifier, and D.C. voltage regulator can be disposed within the electronic device itself or, more commonly, disposed in a power converter (“brick”) that is attached to the electrical device using a power cable. The growing trend of miniaturization within the electrical industry has increased the pressure to minimize the size and weight of electrical devices including power converters while maximizing the functionality of both the electrical device and converter.

### SUMMARY OF THE INVENTION

Systems for providing a power converter having wireless capability are provided. The power converter can include a power converter module having a detachable input/output (“I/O”) module body operably connected thereto. A voltage input, a first voltage output, and second voltage output can be disposed in, on, or about the power converter body. The first voltage output can be distributed via a first connection device. The second voltage output can distribute a D.C. voltage via a first Universal Serial Bus connection device. A wireless transceiver and a second Universal Serial Bus connection device can be disposed in, on, or about the I/O module body. The first and second Universal Serial Bus connection devices can be complimentary, thereby permitting the operable connecting of the I/O module with the power converter module. The second voltage output can provide all or a portion of the power consumed by the wireless transceiver.

An “operable connection”, a connection by which entities are “operably connected”, or the “operable connecting” of two or more entities, is one in which signals, physical communications, and/or logical communications may be sent and/or received. Typically, an operable connection includes a physical interface, an electrical interface, a wireless interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

Methods for providing a power converter having wireless capability are also provided. Power can be supplied to a power converter that can include: a power converter body, a voltage input disposed in, on, or about the body; a first voltage output disposed in, on, or about the power converter body; a second voltage output disposed in, on, or about the power converter body. The first voltage output can be suitable for distributing a first voltage via a first connection device. The second voltage output can be suitable for distributing a first voltage via a first universal serial bus (“USB”) connection device. An I/O module can be operably connected to the first USB connection device. The I/O module can include: an I/O module body; one or more wireless transceivers; and a second USB connection device. The second USB connection device can be suitable for operably connecting with the first USB connection device. All or a portion of the power required by one or more input/output devices (160, 170) disposed in, on, or about the I/O module body can be supplied via the second USB connection device. One or more external devices can be wirelessly operably connected to the one or more wireless transceivers disposed in, on, or about the I/O module body.

### BRIEF DESCRIPTION OF THE DRAWINGS

Advantages of one or more disclosed embodiments may become apparent upon reading the following detailed description and upon reference to the drawings in which:

FIG. 1 is a schematic diagram depicting an exemplary, wireless capable, power converter, according to one or more embodiments described herein;

FIG. 2 is an isometric view depicting the exemplary, wireless capable, power converter depicted in FIG. 1, according to one or more embodiments described herein;

FIG. 3 is a schematic diagram depicting an exemplary system having an exemplary wireless capable power converter, according to one or more embodiments described herein;

FIG. 4 is a schematic diagram depicting another exemplary system having an exemplary wireless capable power converter, according to one or more embodiments described herein; and

FIG. 5 is a schematic diagram depicting yet another exemplary system having an exemplary wireless capable power converter, according to one or more embodiments described herein.

### DETAILED DESCRIPTION

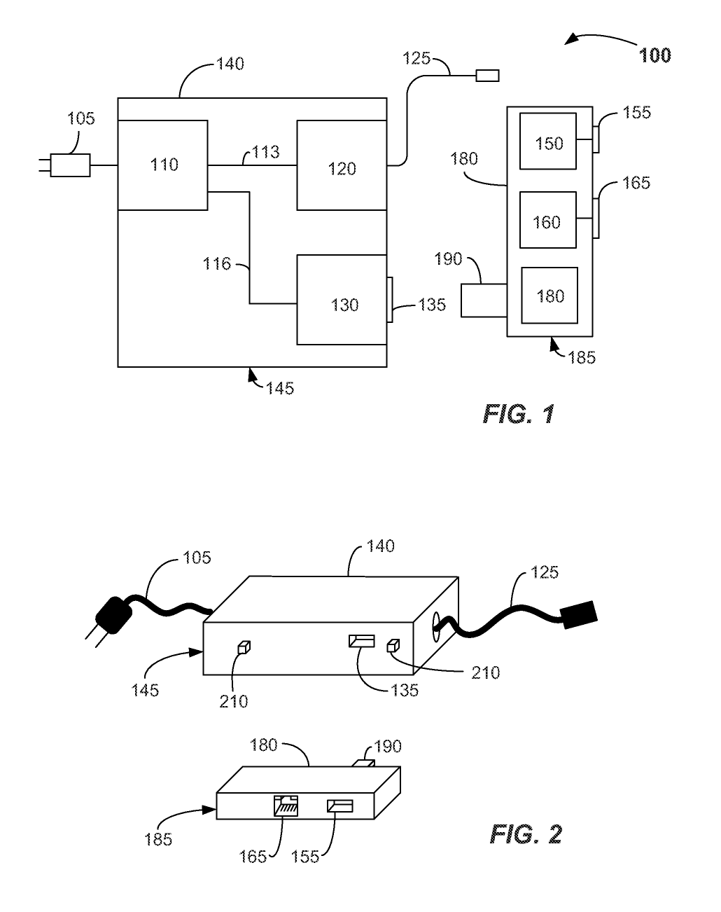

FIG. 1 is a schematic diagram depicting an exemplary, wireless capable, power converter 100, according to one or more embodiments. In one or more embodiments, the power converter 100 can include one or more power converter modules 145 operably connected to one or more input/output (“I/O”) modules 185. In one or more embodiments, the power converter module 145 can include one or more voltage inputs 110, one or more first voltage outputs 120 and one or more second voltage outputs 130. The one or more voltage inputs 110, first voltage outputs 120, and second voltage outputs 130 can be disposed in, on, or about a power converter body 140. In one or more embodiments, the first voltage output 120 can supply power at a first voltage via one or more connection devices 125. In one or more embodiments, the second voltage output 130 can supply power at a second voltage via one or more first connection devices 135. The first voltage supplied via the one or more connection devices 125 can be the same or different than the second voltage supplied via the one or more first connection devices 135.

In one or more embodiments, the I/O module 185 can include one or more first I/O devices 150 operably connected to one or more first I/O interfaces 155; one or more second I/O devices 160 operably connected to one or more second I/O interfaces 165; and one or more wireless transceivers 170, partially or completely disposed in, on, or about the I/O module body 180. In one or more embodiments, one or more second connection devices 190 can be operably connected to the one or more first I/O devices 150, the one or more second 110 devices 160, and/or the one or more wireless transceivers 170. All or a portion of the power required for operation of the one or more first I/O devices 150, one or more second I/O devices 160, and/or one or more wireless transceivers 170 can be supplied by the power converter module 145 via the operably connection between the first and second connection devices (135, 190).

Referring first to the power converter module 145, incoming power can be supplied via one or more power connections 105 to the one or more voltage inputs 110. The incoming power supplied to the one or more voltage inputs 110 can be alternating current (A.C.), direct current (D.C.), or any combination or derivation thereof. The incoming power supplied to the one or more voltage inputs 110 can be at a voltage of from about 5V to about 480V; about 15V to about 300V; about 24V to about 240V; or about 100V to about 240V. In one or more specific embodiments, the incoming power supplied to the one or more voltage inputs 110 can be an alternating current operating at a voltage of from about 110VAC to about 220VAC.

In one or more embodiments, all or a portion of the power supplied to the one or more voltage inputs 110 can be converted or otherwise altered in one or more parameters, including but not limited to waveform, voltage, or any combination thereof. Typical conversion or alterations can include, but are not limited to, voltage increase or reduction via one or more power transformers; waveform rectification, for example from an A.C. waveform to an approximate D.C. waveform via one or more rectification circuits; and/or voltage regulation or conditioning via one or more voltage regulators and/or power conditioners.

In one or more embodiments, the one or more voltage inputs 110 can provide a plurality of power feeds, each having one or more differing characteristics. For example, the one or more voltage inputs 110 can convert a alternating current supplied at 110VAC to a first power feed 113 having a voltage of from about 15VDC to about 45VDC supplied to the first voltage output 120; and a second power feed 116 having a voltage of from about 3VDC to about 10VDC supplied to the second voltage output 130.

In one or more embodiments, all or a portion of the first power feed 113 supplied to the first voltage output 120 can be supplied to one or more electric devices (not depicted in FIG. 1) operably attached to the first voltage output 120 via the one or more connection devices 125. In one or more embodiments, all or a portion of the second power feed 116 supplied to the second voltage output 130 can be supplied to the one or more first connection devices 135.

In one or more embodiments, the one or more first connection devices 135 can include, one or more industry standard connectors including, but not limited to, one or more I.E.E.E. 1394 (“Firewire”) compliant connectors and/or one or more Universal Serial Bus (“USB”) connectors. The one or more first connection devices 135 can include one or more male and/or female connectors. In one or more specific embodiments, the one or more first connection devices 135 can include a female, USB compliant, connector.

In one or more embodiments, all or portion of the one or more voltage inputs 110, first voltage outputs 120, and second voltage outputs 130 can be disposed in, on, or about the power converter body 140. The power converter body 140 can be an open or sealed enclosure suitable for providing protection and appropriate operating conditions for the components disposed in, on, or about the power converter body. The power converter body 140 can be of any suitable material, including metallic, non-metallic, or metallic/non-metallic composites.

Referring next to the I/O module 185, in one or more embodiments, power can be provided to the I/O module 185 via one or more second connection devices 190. In one or more embodiments, the one or more second connection devices 190 can include, one or more industry standard connectors including, but not limited to, one or more I.E.E.E. 1394 (“Firewire”) compliant connectors and/or one or more Universal Serial Bus (“USB”) connectors. The one or more second connection devices 190 can include one or more male and/or female connectors. In one or more specific embodiments, the one or more second connection devices 190 can include a male, USB compliant, connector.

In one or more embodiments, all or a portion of the power supplied to the I/O module via the one or more second connection devices 190 can be provided to the one or more first I/O devices 150. In one or more embodiments, the one or more first I/O devices 150 can include, for example, one or more network adapters, one or more Bluetooth adapters, one or more SATA adapters, one or more I.E.E.E. 1394 adapters, one or more video adapters, or the like. In one or more specific embodiments, the one or more first I/O devices 150 can include one or more network adapters operably connected to one or more first I/O interfaces 155. The one or more first I/O interfaces 155 can include one or more industry standard, modular, connections, for example one or more RJ45 (Ethernet) connections. In one or more specific embodiments, the first I/O device 150 can include one or more network adapters and the second I/O interface 155 can include one or more female, RJ45 compliant, modular, connectors.

In one or more embodiments, all or a portion of the power supplied to the I/O module via the one or more second connection devices 190 can be provided to the one or more second I/O devices 160. In one or more embodiments, the one or more second I/O devices 160 can include, for example, one or more USB hubs, one or more networking hubs, one or more Firewire hubs, or the like. In one or more specific embodiments, the one or more second I/O devices 160 can include one or more USB hubs operably connected to one or more second I/O interfaces 165. The one or more second I/O interfaces 165 can include one or more industry standard connections, for example one or more I.E.E.E. 1394 compliant connections, or one or more USB compliant connections. In one or more specific embodiments, the second I/O device 160 can include one or more USB hubs and the second I/O interface 165 can include one or more female, USB compliant, connectors.

In one or more embodiments, all or a portion of the power supplied to the I/O module via the one or more second connection devices 190 can be provided to one or more wireless transceivers 170. The one or more wireless transceivers 170 can include one or more transceivers suitable for transmitting, receiving, or transmitting and receiving one or more wireless signals using any wireless protocol. In one or more embodiments, the one or more wireless transceivers 170 can include, but are not limited to transceivers compliant with the I.E.E.E. 802.11b/g/n wireless protocol (“WiFi”™); the Ultra-Wide Band (“UWB”) wireless protocol; the Bluetooth wireless protocol; or the like.

In one or more embodiments, all or portion of the more first I/O devices 150; one or more first I/O interfaces 155; one or more second I/O devices 160; one or more second I/O interfaces 165; and one or more wireless transceivers 170, can be disposed in, on, or about the I/O module body 180. The I/O module body 180 can be a partially or completely open or sealed enclosure suitable for providing protection and appropriate operating conditions for the components disposed in, on, or about the I/O module body 180. The I/O module body 180 can be of any suitable material, including metallic, non-metallic, or metallic/non-metallic composites.

FIG. 2 is an isometric view depicting an exemplary wireless capable power converter 100, according to one or more embodiments. FIG. 2 depicts a typical external arrangement or configuration of the exemplary power converter module 145 and an exemplary I/O module 185. In one or more embodiments, the power converter module 145 and the I/O module 185 can be operably connected by coupling, connecting, or otherwise engaging all or a portion of the first connector 135 disposed in, on, or about the power converter module 145 with all or a portion of the second connector 190 disposed in, on, or about the I/O module 185.

As used herein, the term “couple” or “coupled” can refer to any form of direct, indirect, optical or wireless electrical connection. The electrical connection can, in one or more embodiments, include, but is not limited to any electrically conductive or magnetically inductive connection linking two or more devices. The connection can be electrically conductive, for example using one or more conductors such as copper or aluminum wire, conductive strips on a printed circuit board, or the like to connect two or more components. The connection can be magnetically inductive, for example, stimulating the flow of current from a transformer secondary coil by passing a current through a primary coil inductively coupled to the secondary coil. The connection can be electro-magnetic, for example by controlling current flow through a relay contact via an independent relay coil such that passage of a current through the relay coil can magnetically open and close the relay contact.

In one or more specific embodiments, the one or more first connectors 135 can be a female, USB-compliant, connector disposed in, on, or about the power converter module 145. In one or more specific embodiments, the one or more second connectors 190 can be a male, USB-compliant, connector disposed in, on, or about the I/O module 185. Thus, in one or more embodiments, the power converter module 145 and the I/O module 190 can be operably connected or coupled by inserting the second (male USB) connector 190 into the first (female USB) connector 135.

In one or more embodiments, one or more attachment fixtures 210 can be disposed in, on, or about one or more surfaces forming the power converter body 140. One or more complimentary attachment fixtures 210 can be disposed in, on, or about the one or more surfaces forming the I/O module body 180. The attachment fixtures 210 can be used to securely fasten or otherwise affix the I/O module 185 to the power converter module 145.

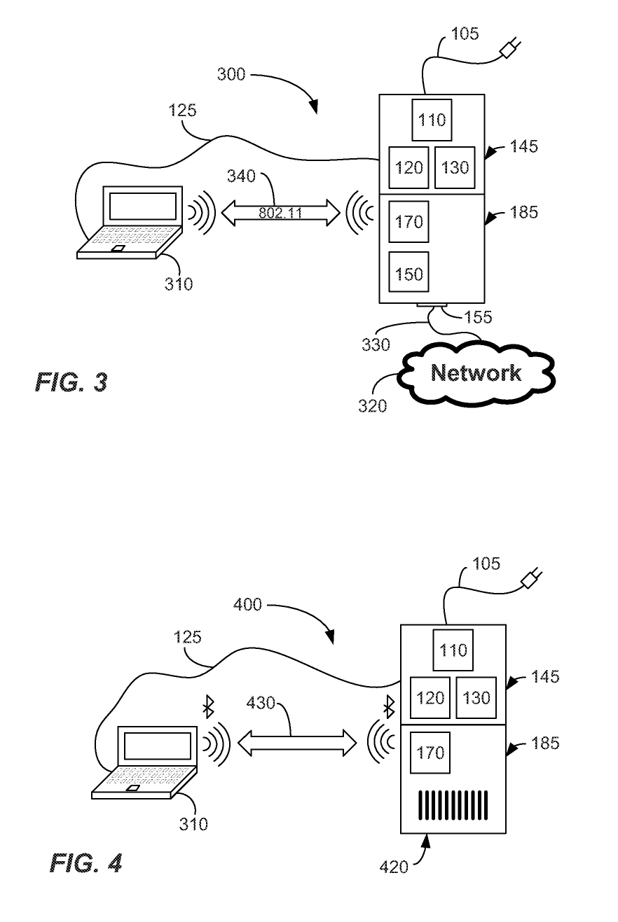

FIG. 3 is a schematic diagram depicting an exemplary system 300 using an exemplary wireless capable power converter 100, according to one or more embodiments. In one or more embodiments, the system 300 can include one or more electronic devices 310, wirelessly operatively coupled 340 to one or more networks 320 via the one or more power converters 100. In one or more embodiments, the one or more connection devices 125 can be used to operatively connect the first voltage output 120 to one or more electronic devices 310.

In one or more embodiments, the I/O module 185 can be operatively connected to the power converter module 145 using one or more first and second connectors (135, 190). In one or more embodiments, the wireless transceiver 170 disposed in, on, or about the I/O module 185 can be wirelessly operatively connected 340 to at least one of the electronic devices 310 powered by the power converter module 145. In one or more embodiments, the wireless operative connection 340 linking the wireless transceiver 170 to at least one electronic device 310 can include an RF connection using an I.E.E.E. 802.11 b/g/n, or similar, communications protocol. Although an I.E.E.E. 802.11 b/g/n compatible wireless operative connection 340 is depicted in FIG. 3 as linking the one or more electronic devices 310 to the I/O module 185, any similar communications protocol can be used to achieve a comparable efficiency and effect.

In one or more embodiments, the one or more first I/O devices 150 can be operably connected to one or more first I/O interfaces 155. In turn, the one or more first I/O interfaces 155 can be operably connected to one or more networks 320. In one or more embodiments, the one or more first I/O interfaces 155 can include, but is not limited to, one or more modular connectors, for example, one or more female, RJ45 type, connectors. The one or more networks 320 can include but are not limited to, one or more local area networks (“LANs”), one or more wide area networks (“WANs”), one or more intranets, the internet, or any combination thereof. Where the one or more first I/O devices 150 are operably connected to a LAN, WAN or intranet, the connection can be, for example, an Ethernet connection using a Category 5 cable 330 having modular, RJ45 connectors disposed on either or both ends of the cable. Such an arrangement can provide Ethernet compatible communications capabilities to any number of electronic devices 310 having wireless capability, without requiring the disposal of an RJ45 compatible modular connector in, on, or about the one or more electronic devices 310.

In one or more embodiments, the electronic device 310 can include any system, device, or combination of systems and/or devices suitable for transmitting a wireless signal 340 to the I/O module 185. The electronic device can include either portable or stationary devices. Exemplary portable devices can include, but are not limited to one or more cellular telephones, one or more portable data assistants, one or more laptop computers, one or more portable computers, one or more netbook computers, or the like. Exemplary stationary devices can include, but are not limited to, one or more desktop computers, one or more workstation computers, one or more data storage devices, or the like.

FIG. 4 is a schematic diagram depicting another exemplary system 400 having an exemplary wireless capable power converter 100, according to one or more embodiments. In one or more embodiments, the system 400 can include one or more electronic devices 310, wirelessly operatively coupled 440 to one or more peripheral devices 420 via the one or more power converters 100. In one or more embodiments, the one or more connection devices 125 can be used to operatively connect the first voltage output 120 to one or more electronic devices 310.

In one or more embodiments, the I/O module 185 can be operatively connected to the power converter module 145 using one or more first and second connectors (135, 190). The wireless transceiver 170 disposed in, on, or about the I/O module 185 can be wirelessly operatively connected 440 to at least one of the electronic devices 310 powered by the power converter module 145. In one or more embodiments, the wireless operative connection 440 between the wireless transceiver 170 and the at least one electronic device 310 can include an RF connection, for example an RF connection using a Bluetooth communications protocol, or the like. Although a Bluetooth compatible wireless operative connection 440 is depicted in FIG. 4 as linking the one or more electronic devices 310 to the I/O module 185, any similar communications protocol can be used to achieve a comparable efficiency and effect.

In one or more embodiments, the one or more peripheral devices 420 can form or otherwise incorporate all or a portion of the I/O module 185. In one or more embodiments, the one or more peripheral devices 420 can be partially or completely disposed in, on, or about the I/O module 185. In one or more embodiments, the one or more peripheral devices 420 can include any type or number of input and/or output devices. For example, the one or more peripheral devices 420 can include one or more video display devices, such as a video projector suitable for the reproduction of all or a portion of one or more video signals provided to the I/O module 185 via the wireless operative connection 440. Similarly, the one or more peripheral devices 420 can include one or more audio transmission devices suitable for the reproduction of all or a portion of one or more audio signals provided to the I/O module 185 via the wireless operative connection 440. In one or more specific embodiments, all or a portion of one or more audio signals can be transmitted or otherwise broadcast by the electronic device 310 to the I/O module 185 via the wireless operative connection 440.

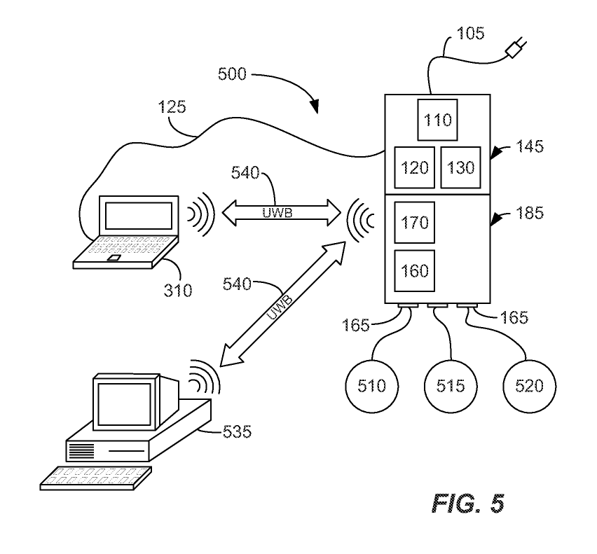

FIG. 5 is a schematic diagram depicting yet another exemplary system 500 having an exemplary wireless capable power converter 100, according to one or more embodiments. In one or more embodiments, the system 500 can include one or more electronic devices (two are depicted in FIGS. 5, 310 and 535) wirelessly operatively coupled 540 to one or more peripheral devices (three are depicted in FIGS. 5: 510, 515, and 520) via the one or more wireless capable power converters 100. In one or more embodiments, the one or more connection devices 125 can be used to operatively connect the first voltage output 120 to one or more electronic devices 310.

In one or more embodiments, the I/O module 185 can be operatively connected to the power converter module 145 using one or more first and second connectors (135 and 190). The wireless transceiver 170 disposed in, on, or about the I/O module 185 can be wirelessly operatively connected 540 to one or more electronic devices 310 powered by the power converter module 145. In one or more embodiments, the wireless operative connection 540 between the wireless transceiver 170 and the one or more electronic devices 310 and 535 can include an RF connection 440, for example an RF connection using an Ultra-Wide Band (“UWB”) communications protocol, or the like. Although a UWB compatible wireless operative connection 540 is depicted in FIG. 5 as linking the one or more electronic devices 310 and 535 to the I/O module 185, any similar communications protocol can be used to achieve a comparable efficiency and effect.

In one or more embodiments, the one or more peripheral devices 510, 515 and 520 can include one or more USB devices, for example storage media; input devices such as keyboards, pointers, and the like; and/or output devices such as displays, speakers, haptic devices, and the like. In one or more embodiments, all or a portion of the one or more peripheral devices 510, 515 and 520 can be operatively connected to one or more second I/O interfaces 165 disposed in, on, or about the I/O module 185. In one or more embodiments, the one or more one or more second I/O interfaces 165 can include, but are not limited to one or more female, USB-compliant, connectors. In one or more embodiments, the one or more peripheral devices 510, 515 and 520 can include any type or number of input and/or output devices. Although an UWB compatible RF signal is depicted in FIG. 5 as linking the electronic devices 310 and 535 to the I/O module 185, any similar RF communications protocol can be used to achieve a similar efficiency and effect. Although one or more USB compliant connectors 165 are discussed above as an exemplary embodiment with reference to FIG. 5, any similar connector, such as an I.E.E.E. 1394 compliant connector can be used to achieve a similar efficiency and effect.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An input/output system, comprising:
an I/O module housing that, when directly affixed to an exterior surface of an external power supply coupled to a first remote electronic device, is configured to;
draw power solely via a power interface from the external power supply; and
couple a second remote electronic device to the first remote electronic device via a wireless link between the I/O module and the first remote electronic device.

2. The system of claim 1, the second remote electronic device coupled to the I/O module via a wireless interface.

3. The system of claim 1, the second remote electronic device coupled to the I/O module via a wired interface.

4. The system of claim 1, the wireless link comprising a bidirectional radio frequency communication link between the I/O module and the first remote electronic device.

5. The system of claim 4, wherein the radio frequency (RF) communication link comprises an RF link compliant with at least one of: a Bluetooth communication protocol; an I.E.E.E. 802.11 (“WiFi”) communication protocol; and an Ultra Wideband (“UWB”) communications protocol.

6. The system of claim 1, the direct affixing of the I/O module housing to the exterior surface of an external power supply comprises:
an attachment fixture disposed on an exterior surface of the I/O module; and
a complimentary attachment fixture disposed on an exterior surface of the external power supply.

7. The system of claim 1, wherein the power interface comprises:
a universal serial bus (USB) connector disposed on an exterior surface of the external power supply; and
a complimentary USB connector disposed on an exterior surface of the I/O module.

8. The system of claim 1, the second remote electronic device comprising a second external power supply.

9. An input/output method, comprising:
directly affixing an I/O module housing to an exterior surface of an external power supply coupled to a first remote electronic device;
powering the I/O module solely from the external power supply via a power interface;
wirelessly coupling a first transceiver disposed within the I/O module and a second transceiver disposed within the first remote electronic device; and
coupling a second remote electronic device to the first remote electronic device via the wireless coupling.

10. The method of claim 9, where powering the I/O module solely from the external power supply via the power interface comprises:
coupling a universal serial bus (USB) connector disposed on an exterior surface of the I/O module to a complimentary USB connector disposed on an exterior surface of the external power supply.

11. The method of claim 9, where directly affixing the I/O module housing to an exterior surface of an external power supply coupled to a first remote electronic device comprises:
engaging an attachment fixture disposed on an exterior surface of the I/O module with a complimentary attachment fixture disposed on an exterior surface of the external power supply.

12. The method of claim 9, where coupling the second remote electronic device to the first remote electronic device via the wireless coupling comprises:
coupling the second remote electronic device to an interface disposed at least partially within the I/O module; and
transmitting I/O data between the second remote electronic device and the first remote electronic device via the first and second transceivers.

13. The method of claim 9, further comprising:
powering the second remote electronic device using a second external power supply.

14. An input/output (I/O) system, comprising:
a first transceiver disposed at least partially within an I/O module, the first transceiver configured to bidirectionally, wirelessly, couple to a second transceiver disposed at least partially within a remote electronic device;
an external power supply configured to:
accommodate the direct affixing of the I/O module to an external surface of the external power supply;
provide power to the remote electronic device; and
provide the sole power source for the I/O module via a power interface when the I/O module is directly affixed to the external power supply; and
an interface for a second remote electronic device disposed at least partially within the I/O module, the interface to provide a coupling between the first remote electronic device and the second remote electronic device via the interface and the wirelessly coupled first and second transceivers;
the second remote electronic device including a second power supply.

15. The system of claim 14, the interface comprising a wireless interface.

16. The system of claim 14, the interface comprising a wired interface.

17. The system of claim 14, the bidirectional wireless coupling between the first and second transceivers comprising an RF link compliant with at least one of: a Bluetooth communication protocol; an I.E.E.E. 802.11 (“WiFi”) communication protocol; and an Ultra Wideband (“UWB”) communications protocol.

18. The system of claim 14, the direct affixing of the I/O module housing to the exterior surface of an external power supply comprises:
an attachment fixture disposed on an exterior surface of the I/O module; and
a complimentary attachment fixture disposed on an exterior surface of the external power supply.

19. The system of claim 14, wherein the power interface comprises:
a universal serial bus (USB) connector disposed on an exterior surface of the external power supply; and
a complimentary USB connector disposed on an exterior surface of the I/O module.
